(19) United States
(12) Patent Application Publication
(10) Pub. No.: US 2008/0276221 A1
(43) Pub. Date: Nov. 6, 2008

(54) METHOD AND APPARATUS FOR RELATIONS PLANNING AND VALIDATION

(75) Inventors: Gil LEV, Raanana (IL); Ronen RUBINFELD, Zichron Yaakov (IL); Yiftach NUN, Kiryat-Ata (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: SAP AG., Walldorf (DE)

(21) Appl. No.: 11/743,188

(22) Filed: May 2, 2007

(51) Int. Cl. G06F 9/44

(52) U.S. Cl. 717/120

(57) ABSTRACT

A method and apparatus for validating at least one rule in a system containing objects related by relationships. The objects can be software components and the relationships can be a containing relationship or a dependency relationship. The input and output of the system can be of pre-defined or user-specific formats, and the validated rules can also be out of the box, or user-supplied. The apparatus generates an internal model upon which the rules are validated. The method and apparatus can be used for testing software, for instance.

### BACKGROUND OF THE INVENTION

1. Field of the Invention

The present invention relates to checking dependencies in general, and to a method and apparatus for checking problems in the design, deployment and usage of multi-dependency components in particular.

2. Discussion of the Related Art

Large scale systems, such as software systems present multiple dependency problems in various stages of a products life cycle. Software systems, for example, present multiple types of components, such as classes, source files, configuration files, object files, java deployable components, or other software components, development components, or the like. The components can be related via multiple relationships, including but not limited to, inclusion, programming dependency, deployment weak dependency (e.g., component A depends weakly on component B if for deploying component A, component B should already be deployed), deployment strong dependency (e.g., component A depends strongly on component B if for deploying component A, component B should already be running), and run time dependency. Two entities may be related in multiple different modes, depending on the stage. For example, component A may require the existence of component B in design time, and the running of component B in run-time. Another type of problem may result from dead-lock situations, in which the deployment of component A requires component B, while the deployment of component B requires component A (or a circle having three or more components, such as A depending on B, B depending on C, and C depending on A). Yet another type of problem may result from multiple instances of a certain components. For example, component A may depend on component B as stored on a specific computing platform, while component C depends on component B which is stored on another computing platform. Such a situation may lead to a conflict which can result in run time problems.

There is therefore a need in the art for a method and apparatus which can receive the description of the objects and dependencies between them, and provide indications of problems that may occur when using the objects, wherein, the objects may be used in a variety of ways, which imply on their interconnections. The solution could be adapted for any type of problem involving entities and relationships, such as chemistry, manufacturing environments, or the like. As far as computerized systems are involved, it is desired that the solution will be functional in discovering not only compilation and deployment problems, but also possible runtime problems prior to or even during development, before significant resources are invested into developing a defective product. Thus, a design can be corrected prior to development, which is generally more efficient, cheaper, and provides better results than correcting the finished product itself.

### SUMMARY

The disclosed method and apparatus receive the description of objects and interdependencies between the objects, and validates the description and interdependencies. The validation provided indications of problems that may occur when the objects are used. Optionally, the objects may be used in a variety of ways, wherein the usage has implications the interconnections. The method and apparatus can be adapted for any type of problem which involves entities and relationships, including computerized systems, chemistry, manufacturing environments and processes, or the like. When the problem involves computerized environments, the method and apparatus enable the discovery during planning an development of problems that will appear in the stages of compilation, deployment, or runtime. Thus, problems will be detected before significant resources are invested into developing a defective product, and a problematic design can be corrected prior to development. This provides for more efficient, cheaper, and better results than correcting a finished product itself.

A first aspect of the disclosed subject matter relates to a method executed by a computing platform for validating a rule in a system, the system comprising two or more objects, the two or more objects related in one or more relationships, the method comprising the steps of: receiving a description of the objects and the relationships; generating a model from the description; validating the rule on the model, for obtaining one or more results; and outputting the results using one or more output types. The method can further comprise a step of converting the results into the output types. The method optionally comprises a step of converting a user input into an object and relationship representation. Optionally, the method further comprises a step of outputting a presentation of the model. The method can further comprise a step of updating the model through changing the representation. Within the method, the rule can relate to design of a software product, compilation of a software product, deployment of a software product, or to a runtime problem in a software product. Within the method the rule is optionally selected from the group consisting of: identifying a missing object, detecting a circle, installation order, validating a usage order of multiple objects, detecting duplicate objects, detecting critical objects and detecting objects from multiple objects. The method optionally comprises a step of usage order generation. The description of the two or more objects and the relationships can be in form of a text file, an XML file or a spreadsheet. The output type can be in form of a text file, an XML file, or a spreadsheet. The relationships can comprise a containing relationship or a dependency relationship. The two or more objects can be software components. The model is optionally a graph.

Another aspect of the disclosed subject matter relates to an apparatus executed by a computing platform for validating a rule in a system, the system comprising two or more objects, the objects related in a relationship of a relationship type, the apparatus comprising: one or more input translators for translating a description of the objects and the relationship into a predetermined format; an input translator engine for activating the input translators; an engine for activating a specific engine; a model building engine for building a model according to the predetermined format; and a rules engine for validating the rule on the predetermined model and obtaining one or more results. The apparatus can further comprise one or more output translators for translating the results into output formats, and an output translator engine for activating the output translators. Within the apparatus, the input translators or output translators the can be plug-ins of the system. The apparatus optionally comprises a pluggable rule engine comprising one or more rules to be activated by the rules engine. Optionally, the apparatus comprises a visualization engine for outputting a presentation of the model. Within the apparatus, the rules are optionally selected from the group consisting of: identifying a missing object; detecting a circle; installation order; validating a usage order of multiple objects; detecting duplicate objects; detecting critical objects, and detecting objects from multiple objects. The description of the objects and the relationships can be in format selected from the group consisting of: a text file, an XML file, and a spreadsheet. The output type can be in format selected from the group consisting of a text file, an XML file, and a spreadsheet. The relationship is optionally a containing relationship or a dependency relationship. The two or more objects can be software components.

Yet another aspect relates to a computer readable storage medium containing a set of instructions for a general purpose computer, the set of instructions comprising: receiving a description of two or more objects and a relationship between the objects; generating a model from the description; validating a rule on the model, for obtaining a result; and outputting the result using the output type.

### BRIEF DESCRIPTION OF THE DRAWINGS

Non-limiting embodiments of the invention will be described with reference to the following description of exemplary embodiments, in conjunction with the figures. The figures are generally not shown to scale and any sizes are only meant to be exemplary and not necessarily limiting. In the figures, identical structures, elements or parts that appear in more than one figure are preferably labeled with a same or similar number in all the figures in which they appear, in which:

FIG. 1 is a flowchart of steps in an exemplary method for verifying relationships of objects;

FIG. 2 is a block diagram of an exemplary apparatus for verifying relationships of objects;

FIGS. 3A and 3B are schematic illustrations of relationships between objects; and

FIG. 4 is a schematic illustration of an internal model of an evaluated system for verifying relationships of objects.

### DETAILED DESCRIPTION

The provided tool and method receives as input a description of multiple objects, and the interrelationship between the objects, wherein the interrelationships may depend upon the situation. The relationships between objects may be containing relationship, a requirement relationship or another. The relationship can be or 1:1, i.e. one object on each end of the relationship; 1:n, i.e. one object on one side and multiple objects on the other side of the relationship, or n:m, i.e. multiple objects on either side of the relationship. The input may be provided in a variety of formats, such as XML, a spreadsheet, a text file, or any other format provided by the user. The tool generates an internal data structure representing the dependencies for each situation, and optionally provides a visual representation of the objects and dependencies. The tool then optionally checks for one or more rules defining limitations on the dependencies, and outputs the results in one or more formats. For example, the input may concern a description of a software system, comprising classes, development components (software components which are usually general and are possibly referred to by multiple other components through a well-defined interface, software components often serve as reusable units), software components (which are usually more specific and possibly use one or more development components), code files, archive files such as Java deployable, or the like. The dependencies between the objects may relate to compilation time, such as: for compiling development component A, file B must be present; class D must be present for compiling class C or the like. Further relationships may relate to deploy time, in which case the dependencies can be, for example: for deploying component A, component B must be deployed; or for deploying component C, component D must be running. Yet further relationships may relate to runtime, in which case a relationship may require the presence, deployment or running of an object to enable another object to run. The input may be provided in any supported formats, such as a datasheet, a text file, or others, or in a user-defined format. Rules to be checked may include, for example: an object may not be included multiple times in a project; a deadlock, i.e. a situation wherein component A depends on component B and component B depends on component A is forbidden, or the like. A set of rules may come with the tool, and further rules may be defined and implemented by a user. The output of the tool may include the graphic representation, and further details, such as details relating to violated rules. The output may also take one or more formats, including a visual representation using a graphic tool, a table, a text file, an XML file, a spreadsheet, or any other format which may be supplied by a user of the disclosed invention.

The disclosed invention is typically used on a computing platform such as a such as a personal computer, a mainframe computer, or any other type of computing platform that is provisioned with a memory device, a CPU or microprocessor device, and several I/O ports. Alternatively, the device can be implemented on firmware ported for a specific processor such as digital signal processor (DSP) or microcontrollers, or as hardware or configurable hardware such as field programmable gate array (FPGA) or application specific integrated circuit (ASIC). The disclosed invention is preferably implemented as an executable running on said computing platform. The executable is comprised of one or more units containing instructions, such as static libraries, dynamic link libraries, or the like. In an alternative embodiment, the environment comprises multiple computing platforms connected in a network such as a local area network, a wide area network, the internet or the like. One or more of the computing platforms execute commands associated with the disclosed methods, while a user can provide the apparatus with input, or receive output through the same or different connected computing platforms. The commands can be written in any programming language, such as C, C#, C++, Java, VB, VB.Net or the like, and be developed under any development environment, such as J2EE, .Net, or the like. One or more of the computing platform receives a description of one or more projects comprised of components, and a set of rules and checks validates whether the project adheres to the rules. The apparatus of the disclosed invention may include various computer readable media having suitable software thereon, for example, diskettes and computer and/or flash RAM.

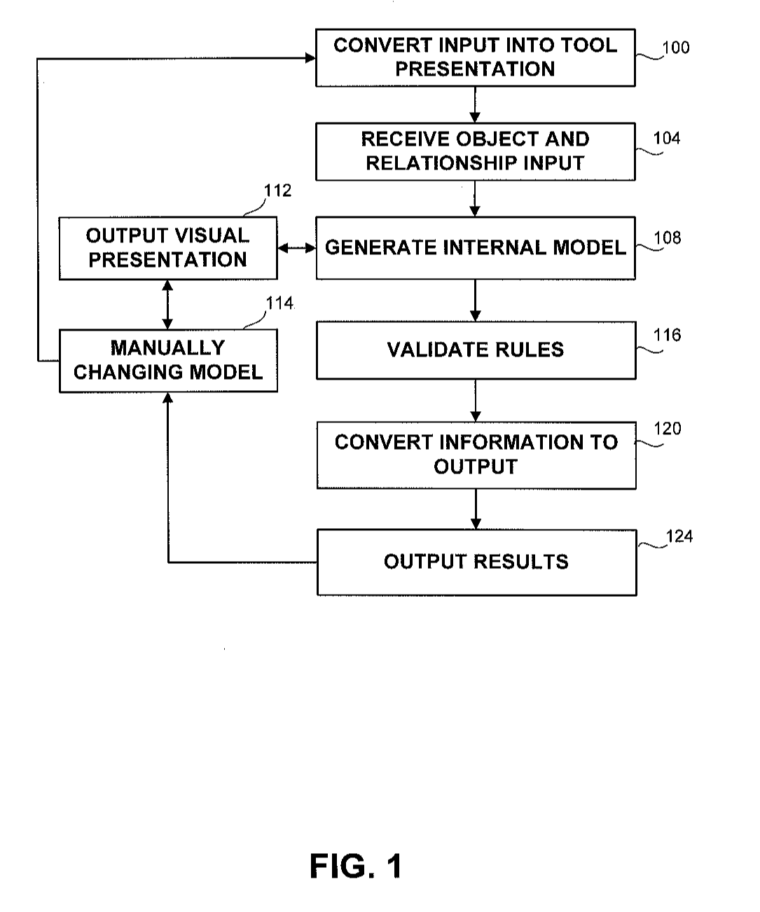

Reference is now made to FIG. 1, showing a flowchart of a method for verifying relationships of objects related to a program. The method starts by the system receiving a description of the objects and relationships at step 104. However, if the input is in a user-specific format, which is not supported by a system implementing the method, on step 100 the input is converted into a uniform tool presentation, comprising objects and relationships. The user may employ computer instructions or other mechanisms for converting the user-specific input into a uniform presentation used by the system. The user should identify the objects and relationships from within the description, and activate the application program interface (API) of the system, which preferably includes the following exemplary functions, for instance:
Add Object (Object ID, properties); and
Add Relation (Object1 ID, Object2 ID, direction, properties).
   Calling these methods for all objects and all relationships in the input will emulate a situation wherein an existing format is used in step 100 rather than a user-specific format. Step 100 can be skipped by a user if the input is in a supported format such as an XML file containing the desired tags, which can be directly received by a system implementing the method. The function of AddObject is preferably called for each object identified in the tested system, and the required parameters should include an identifier for the object, and relevant properties, if any, such as presentation name of the object, creator name of the object, or the like. The function of AddRelation is called for each relation between a first and a second objects, and its parameters should include identifiers of the first and the second object, the relation direction, such as first-to-second, second-to-first, or bidirectional, and properties of the relation, such as multiplicity. On step 104, the system receives the description of the objects, relationships and relationship types, whether in a pre-supported format, such as an XML file, text file, a spreadsheet, a binary object or the like, or after being adjusted to the system on step 100. It will be appreciated by a person skilled in the art that for meaningful operation, at least two objects related in an at least one relationship should be provided. The input describes the objects in the system, including identification such as a name, and optionally a type. The relationships include: the relationship type, such as “contains”, “depends”, or the like; the two related entities; a direction (A depends on B, B depends on A, or both); a multiplicity (1:1, 1:N, N:1, or N:M); and optionally an additional parameter representing the environment, such as “compilation”, “deploy”, “run time”, or the like. At step 108, an internal structure is generated from the objects and relationships. The model is preferably a graph data structure, comprising vertices and edges. In one embodiment, the vertices of the graph are the objects, and the edges are the relationships. Each vertex and each edge carries the properties that were provided for the relevant object or relationship, including identification, direction, multiplicity and possibly additional properties. At optional step 112, a representation of the model, such as a visual representation is provided. The presentation can be performed by a dedicated component (such as a third party component) or by adjusting the graph data structure and using a third patty tool for receiving an XML file and generating a graphic representation, such as yED manufactured by yWorks of Tübingen, Germany, or ILOG JViews Diagrammer manufactured by ILOG of Gentilly, France. The graph can show at least containing relationships and dependencies relationships between two or more objects.

It will be appreciated by a person skilled that manually updating model step 114 can be used to change the underlying model, which can be used for assessing solutions to problematic situations. For example, suppose the model comprises a deadlock situation presented as a loop in the graph. Using input devices such as keyboard, a mouse, or another pointing device, the user can move an object within the graph to another location, implying for example, moving an object A from being contained within object B into being contained within object C, thus breaking a loop. The user can move objects or break relationships on the graphic representation, check the implications, and when the result is satisfactory, perform the real action on the objects themselves, for example move a class definition from one software component to another software component. Optionally, the user's changes are reflected into an updated description and are fed back into the system by re-entering step 100 for re-evaluation.

On step 116 the model is checked against pre-provided rules for correctness, and an at least one result, such as a pass/fail result for the rule is obtained. For example, the existence of a dead-lock situation is detected via the existence of a closed loop comprising two or more vertices in the graph, wherein the edges connecting the vertices are of relevant types and the relevant direction. For example, if compiling file A requires file B to be compiled, and compiling file B requires file A to be compiled, then such situation needs to be detected and corrected. Circles can be detected using any known algorithm, such as Breadth First Search (BFS), Depth First Search (DFS) or others. Each situation can be detected using generally known algorithms or user-supplied algorithms. Default rules are preferably supplied with an apparatus according to the disclosed invention. However, a user can define additional rules to be checked. For this purpose, an application program interface (API) may be used which provides access to the data structure, including the edges, the vertices and their properties, and enables a user to perform any algorithm for detecting any situation. Thus, any rule which can be validated by performing a known or a new algorithm on the data structure can be incorporated into the tool, either as an out-of-the-box rule or as an add-on.

Out-of-the-box rules may include any one or more of the following: A. Identifying a missing object. An object is referred to by another object, but is not present. B. detecting a circle as detailed above. C. Usage order: the method can validate the usage, such as installation or deployment order of multiple objects or components which assures that if a first component requires that other components are operative as prerequisites to the activation of the first component, the other components are indeed activated. The method can further generate a usage order, such as an installation order that satisfies the requirement. D. Duplications: if the same object, such as a class appears twice, this can cause problems such as compilation or linking problems in development times caused by the multiple objects, and run time problems later on, such as possible inconsistencies between the object's duplications. E. A critical object: an object that is referred to by multiple other objects can be identified. Such component may be subject to more intensive quality assurance than other components. F. Platform object: an object that is contained or referenced from multiple locations, may be packaged separately, and accessed from all locations, thus avoiding the risk of incompatible versions and the need to update all containing components when a change is introduced into the object. G. Reduction of unnecessary components: unreachable components or components that are neither accessed by any other component nor directly by a user may be deleted from a project. Any

Optional step 120 is functional in converting the results, i.e. the detected situations, to a format required by the user, if such format is not supported. On step 124 the results, optionally after being converted to a user format are output to one or more destinations. The destinations can be a text file, an XML file, a spreadsheet, or a format supplied by the user, for which the results were converted on step 120. Optionally, the output can be fed into step 114 in which it is changed by a user, and then fed back to step 100 for re-evaluation.

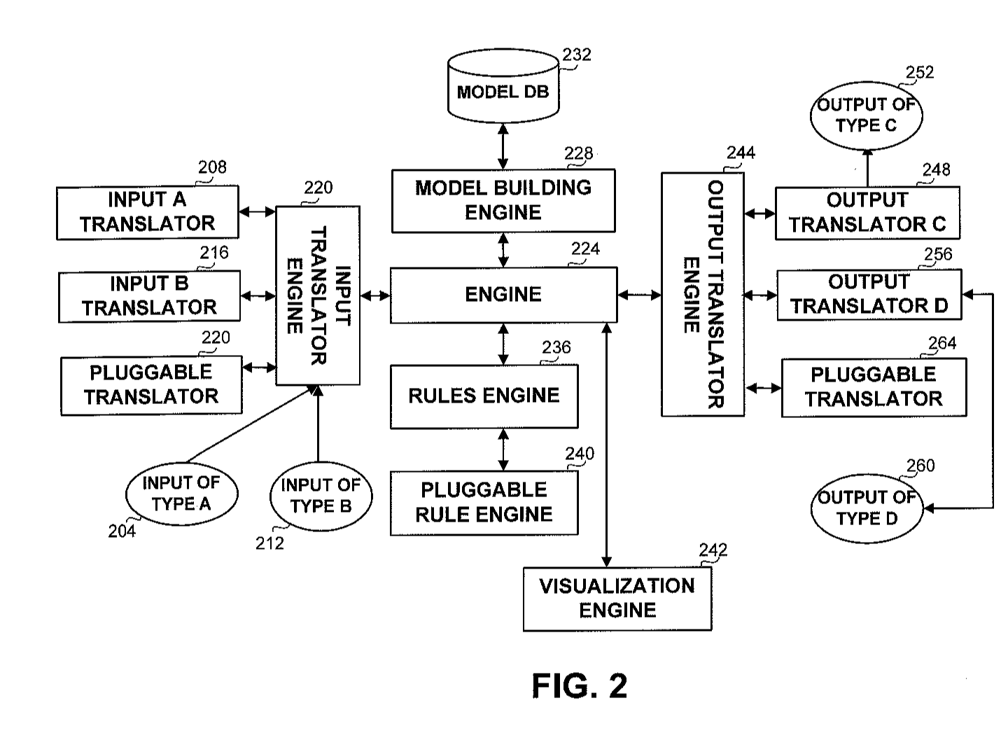

Reference is now made to FIG. 2, showing a preferred embodiment of the apparatus of the disclosed invention. The apparatus receives input describing objects and relationship within a project in multiple formats. Each format supported by the system has a translator for translating the input into an internal format of the system, such as input A translator 208 or input B translator 216. The formats can be, for example, an XML file, a text file, a spreadsheet or the like. If the user wishes to use a format not supported by the system, he or she may supply an external, desirably pluggable translator 220, as explained in association with step 104 of FIG. 1 above. The input of any type is received by input translator engine 220, which activates the relevant input translator, such as translator 208, translator 216, translator 220 or others according to the input type. In the case of input of type A 204, input A translator 208 is activated, in the case of input of type B 212, input A translator 216 is activated, and for input of user-specific type, one of the pluggable translators such as translator 220 are used.

A further input translator can be an engine that receives programmatic units, such as a “make” file or a “Project” indicating one or more source files, header files, or other programming units. Such engine retrieves the involved objects and deduces such relationships as containing and dependency relationships between the objects. Optionally, the translator also relates to information contained within one or more files, for example by extracting the header files referred to from source files. Another option refers to accessing a source control system and extracting relevant software components from relevant branches. The translated input, in internal format is transferred to engine 224, responsible for activating the specific engines. Engine 224 calls model building engine 228, which constructs the internal model, preferably a graph comprising objects as vertices and relationships as edges. Model building engine 228 optionally communicates with model database 232, for storing new or updated models or retrieving existing models. Once a model of the project is generated, engine 224 calls rules engine 236 which validates one or more rules regarding the model, as requested by the user.

The rules may be pre-existing within the apparatus, such as rules intended to check for deadlock situations, or additional rules supplies by the user. The additional rules are checked by pluggable rule engine 240, supplied by the user in order to support additional rules. Engine 224 can optionally activate visualization engine 242. Visualization engine 242 is preferably activated upon user request, and provides a visualization of the model, and optionally the checked rules. Visualization engine can be an engine which is an integral part of the apparatus or an external engine, used for example by calling an abstract program interface (API). Visualization engine can further support editing by a user, such as changing relationships between objects, and checking the impact. Once the rules have been checked, the results, such as the violated rules and additional information, (e.g., objects participating in a deadlock) are output by output translator engine 244. Engine 244 calls the relevant output translator such as output translator C 248 which produces output of type C 252 or output translator D 256 which produces output of type D 264. Some output translators, such as an output translator to an XML format, or an output translator to a text file may be implemented as part of the disclosed apparatus, while additional translators may be provided by a user requiring special formats. Such additional translator is preferably implemented as a plug-in translator 264.

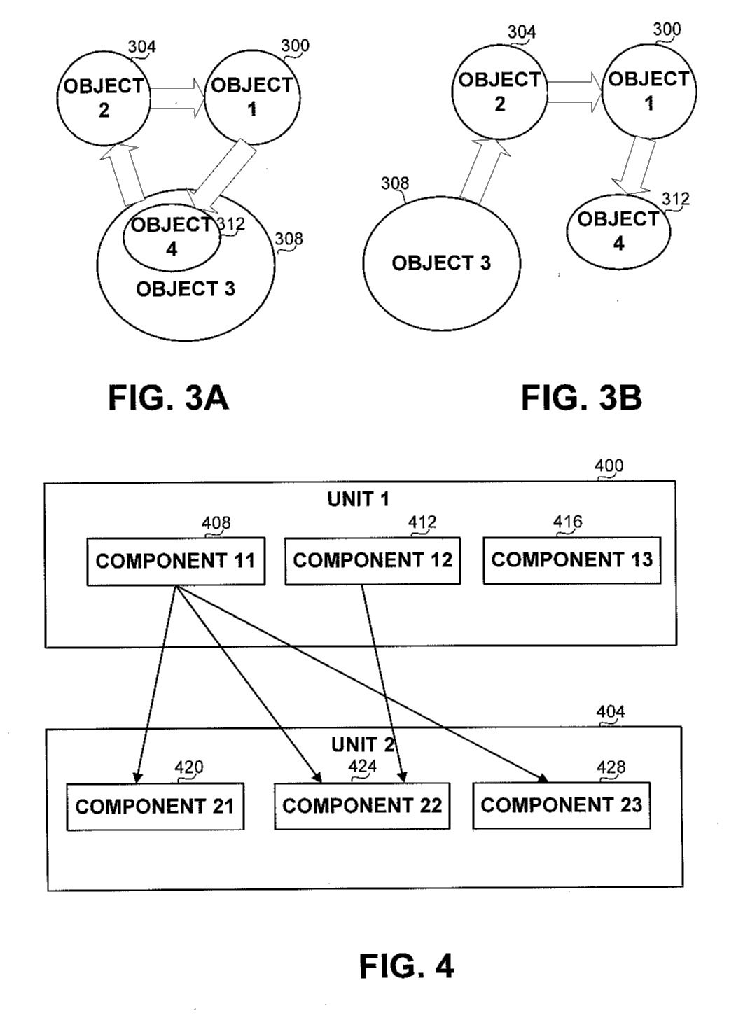

FIGS. 3A and 3B, illustrate an exemplary circle situation and a solution. In the situation depicted in FIG. 3A, in order to deploy (or compile) object 1 (300), object 2 (304) needs to be compiled or deployed first. For object 2 (304) to compile, object 3 (308) needs to be compiled. However, object 3 (308) contains object 4 (312), which requires object 1 (300) to be compiled. Once the situation is detected, for example in a graphic visualization, or in a table in which all cells that participate in a loop have a distinct color or pattern, the situation can be resolved, as seen in FIG. 3B. If the containing relationship between object 3 (308) and object 4 (312) can be eliminated, then the circle is broken and all components can be compiled or deployed.

FIG. 4 is a schematic illustration of an internal model of an evaluated system containing objects and components, as output at step 112 of FIG. 1. The shown visualization presents unit 1 (400) and unit 2 (404), wherein unit 1 (400) comprises component 11 (408), component 12 (412), and component 13 (416), and unit 2 (404) comprises component 21 (420), component 22 (424), and component 23 (428). If the output required by the user is graphic, then after the rules have been validated, one or more rule results can also be visualized. For example, if a circle is detected, the edges of the circle can have a distinct color, a platform component can have a distinct pattern or the like.

The disclosed method and apparatus provide for validating and checking rules or limitations in a system in which components are connected in relationships such as containing relationships or dependence relationships. The relationships between two or more objects may vary in different situations, including stages of the life-cycle of the system. For example, if the product is a computerized system, the stages may include compiling (or otherwise constructing the system), deploying, or run-rime (or otherwise using the system). Early discovery of advanced stages in the life cycle of the product, such as deployment and run-time problems in a computerized system, serve for enhancing the design of a product before resources had been invested in development. Such early discovery enables corrections when such corrections are still relatively easy, cheap, and provide consistent product and results. A model is generated based on the description, and rules are validated against the model. The validated rules may include out-of-the-box rules, as well as user-defined and user-implemented rules, which use an API to access the model, and may be plugged in into the system. The input and output of the system are of various types and formats, some of which may be out-of-the-box types or formats, while others may be required by the user and implemented using plug-in components for supplying the required functionality.

It will be further appreciated that the disclosed method and apparatus are not limited to validating rules related to software. Rather, the method and apparatus can be used for any environment wherein containing and dependency rules are to be validated, such as chemical, biological, physical processes or the like.

The present invention has been described using non-limiting detailed descriptions of embodiments thereof that are provided by way of example and are not intended to limit the scope of the invention. It should be understood that features described with respect to one embodiment may be used with other embodiments and that not all embodiments of the invention have all of the features shown in a particular figure or described with respect to one of the embodiments. It is noted that some of the above described embodiments may describe the best mode contemplated by the inventors and therefore include structure, acts or details of structures and acts that may not be essential to the invention and which are described as examples.

The present invention is not limited to what has been particularly shown and described hereinabove. Structure and acts described herein are replaceable by equivalents, which perform the same function, even if the structure or acts are different, as known in the art. The scope of the present invention is defined only by the claims which follow. When used in the following claims, the terms “comprise”, “include”, “have” and their conjugates mean “including but not limited to”.

1. A method executed by a computing platform for validating an at least one rule in a system, the system comprising at least two objects, the at least two objects related in an at least one relationship, the method comprising the steps of:
receiving a description of the at least two objects and the at least one relationship;
generating a model from the description;
validating the at least one rule on the model, for obtaining an at least one result; and
outputting the at least one result using an at least one output type.

2. The method of claim 1 further comprising a step of converting the at least one result into the output type.

3. The method of claim 1 further comprising a step of converting a user input into an object and relationship representation.

4. The method of claim 1 further comprising a step of outputting a presentation of the model.

5. The method of claim 4 further comprising a step of updating the model through changing the representation.

6. The method of claim 1 wherein the at least one rule relates to design of a software product, compilation of a software product, deployment of a software product or runtime problem in a software product.

7. The method of claim 1 wherein the at least one rule is selected from the group consisting of: identifying a missing object, detecting a circle, installation order, validating a usage order of multiple objects, detecting duplicate objects, detecting critical objects and detecting objects from multiple objects.

8. The method of claim 7 further comprising a step of usage order generation.

9. The method of claim 1 wherein the description of the at least two objects and the at least one relationship is in form of a text file, an XML file or a spreadsheet.

10. The method of claim 1 wherein the output type is in form of a text file, an XML file, or a spreadsheet.

11. The method of claim 1 wherein the at least one relationship is a containing relationship or a dependency relationship.

12. The method of claim 1 wherein the at least two objects are software components.

13. The method of claim 1 wherein the model is a graph.

14. An apparatus executed by a computing platform for validating at least one rule in a system, the system comprising at least two objects, the objects related in at least one relationship of at least one relationship type, the apparatus comprising:
at least one input translator for translating a description of the at least two objects and the at least one relationship into a predetermined format;
an input translator engine for activating the at least one input translator;
an engine for activating an at least one specific engine;
a model building engine for building a model according to the predetermined format; and
a rules engine for validating the at least one rule on the predetermined model and obtaining an at least one result.

15. The apparatus of claim 14 further comprising:
at least one output translator for translating the at least one result into an output format; and
an output translator engine for activating the at least one output translator.

16. The apparatus of claim 14 wherein the at least one input translator is a plug-in of the system.

17. The apparatus of claim 15 wherein the at least one output translator is a plug-in of the system.

18. The apparatus of claim 14 further comprising a pluggable rule engine comprising an at least one rule to be activated by the rules engine.

19. The apparatus of claim 14 further comprising a visualization engine for outputting a presentation of the model.

20. The apparatus of claim 14 wherein the at least one rule is selected from the group consisting of identifying a missing object; detecting a circle; installation order; validating a usage order of multiple objects; detecting duplicate objects; detecting critical objects; and detecting objects from multiple objects.

21. The apparatus of claim 14 wherein the description of the at least two objects and the at least one relationship is in format selected from the group consisting of: a text file, an XML file, and a spreadsheet.

22. The apparatus of claim 14 wherein the output type is selected from the group consisting of: a text file, an XML file, and a spreadsheet.

23. The apparatus of claim 14 wherein the at least one relationship is taken from the group consisting of: a containing relationship and a dependency relationship.

24. The apparatus of claim 14 wherein the at least two objects are software components.

25. A computer readable storage medium containing a set of instructions for a general purpose computer, the set of instructions comprising:
receiving a description of at least two objects and at least one relationship between the at least two objects;
generating a model from the description;
validating at least one rule on the model, for obtaining an at least one result; and
outputting the at least one result using the output type.
